(19) United States
(12) Patent Application Publication
(10) Pub. No.: US 2007/0011225 A1
(43) Pub. Date: Jan. 11, 2007

(54) [MULTIMEDIA PLAYER]

(75) Inventors: Chih-Jen Hsu, TAIPEI (TW); Sheng-Yu Chang, TAIPEI (TW)

Correspondence Address: PHISON ELECTRONICS CORPORATION, 2F-4. NO. 148, SEC. 4, CHUNG HSIAO EAST ROAD, TAIPEI, TW

(73) Assignee: PHISON ELECTRONICS CORP., Chutung Town, Hsinchu Hsien (TW)

(21) Appl. No.: 11/160,766

(22) Filed: Jul. 7, 2005

(51) Int. Cl. G06F 15/16

(52) U.S. Cl. 709/201

(57) ABSTRACT

A multimedia player is disclosed. The multimedia player comprises a host end and a receiving end. The host end comprises a transmission interface, a wireless transmission interface and a host connected to the transmission interface and the wireless transmission interface. The transmission interface is adopted for connecting to the Internet for downloading and transmitting a multimedia entertainment content. The receiving end comprises a microcontroller connected to a wireless transmission interface adopted for receiving the multimedia entertainment content transmitted from the wireless transmission interface of the host end, and a digital/analog converter for converting the multimedia entertainment content into a playable format for a playing device. The microcontroller and the digital/analog converter are connected to a monitor and said playing device respectively.

### BACKGROUND OF THE INVENTION

1. Field of the Invention

The present invention is related to a multimedia player, and particularly, to a multimedia player comprising a host end for receiving the multimedia entertainment content via the Internet and a receiving end for playing the multimedia entertainment content. Thus, the multimedia player of the present invention may also be adopted to wirelessly receive and play the multimedia entertainment content.

2. Background of the Related Art

With the maturity of the PC applications, the information products have gradually become the household electronic appliances. In the past time, the computers were usually applied for business use. Now, computer not only can play DVD, games but also directly display television programs using an adaptor. Such new applications of computers paved a way for the manufacturers develop products with more powerful multimedia functions, such as playing 3D games and DVD. Furthermore, the barebone system, which provides the advantage of easy assembly of the computer, also produce mini computer. Thus, not only occupation of space can be substantially reduced but also the product is capable executing more powerful functions such as playing music and DVD without turning on the power by directly combining the computer with the stereo system and the DVD player. Besides, the shape and appearance of the conventional computer case is a box, and at present, the mini computer can be manufactured with more fashionable appearance to substantially as a part of a decoration inside the house.

Accordingly, the manufacturers developed the portable multimedia can compare with the notebook computer, that the user may carry the multimedia entertainment. However, as the storage capacity depends on the size of the storage media, therefore this limits further expansion of the multimedia. Therefore, the above conventional multimedia is not suitable storing and playing long-hours entertainment programs.

Furthermore, wireless technologies are well developed nowadays, the daily activities of the users and the mobile technologies are closely interconnected, and the variety of the functions of the wireless technologies can be integrated within a single household electronic appliance, such as computer, TV set, refrigerator and stereo system that support and can be controlled to communicate with each other. The user may use a mobile device to easily control these devices and enjoy the benefit of wireless digital life. Therefore, if the wireless technology can be integrated with the multimedia, the development of the multimedia can definitely reach a higher prospect.

Furthermore, the copyright of the digital music is always argument legal issues for the digital music if the user uses the multimedia or other device to store the digital music. This can be the big headache for the user.

Therefore, how to improve the aforementioned problems of the conventional art is a very important issue to the manufacturers in the field.

### SUMMARY OF THE INVENTION

Accordingly, in the view of the foregoing, the present inventor makes a detailed study of related art to evaluate and consider, and uses years of accumulated experience in this field, and through several experiments, to create a new wireless multimedia.

According to an aspect of the present invention, the multimedia player comprises the wireless transmission interface of the receiving end for receiving the multimedia entertainment content transmitted from the host end. Thus, the usage duration of the receiving end will not be limited by the capacity of the storage device, and the user may freely and limitlessly enjoy the multimedia entertainment content.

According to the other aspect of the present invention, the host end comprises the transmission interface for connecting to the Internet enabling the user to download the multimedia entertainment content via the Internet. The wireless transmission interface of the host end can be adopted for transmitting the multimedia entertainment content to the receiving end for playing the received multimedia entertainment content. Thus, the multimedia player can be with limitless capability.

According to the another aspect of the present invention, the wireless transmission interface of the receiving end receives and plays the multimedia entertainment content transmitted from the host end with a quality similar or superior to radio without extra charge. The user may pay to gain the authorization code transmitted from the host end if the user desires to save the multimedia entertainment content. Thus, the user can legally enjoy the multimedia entertainment content.

### BRIEF DESCRIPTION OF THE DRAWING

For a more complete understanding of the present invention, reference will now be made to the following detailed description of preferred embodiments taken in conjunction with the following accompanying drawings.

FIG. 1 is a block diagram of a multimedia player according to an embodiment of the present invention.

FIG. 2 is a block diagram of a key of a host end setup in a multimedia entertainment content of the multimedia player according to an embodiment of the present invention.

### DETAILED DESCRIPTION OF THE EMBODIMENTS

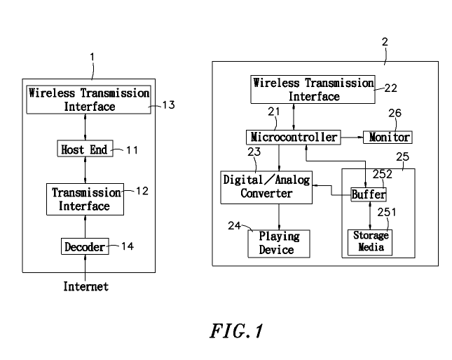

Referring to FIG. 1, the multimedia player comprises a host end 1 and a receiving end 2. The host end 1 comprises a host 11, a transmission interface 12, a wireless transmission interface 13 and a decoder 14. The receiving end 2 comprises a microcontroller 21, a wireless transmission interface 22, a digital/analog converter 23, a playing device 24, a storage device 25 and a monitor 26.

The host 11 is adopted for controlling the operation of the transmission interface 12 and the wireless transmission interface 13. The host 11 may be a computer.

The transmission interface 12 is connected to the host 11, and it may also be connected to the Internet.

The wireless transmission interface 13 is connected to the host 11 and can send out a multimedia entertainment content transmitted from the host 11. The multimedia entertainment content can be the audio/video data or the digital music.

The decoder 14 is connected to the transmission interface 12, and the decoder 14 may be adopted to convert the multimedia entertainment content into a playable format for the receiving end 2.

The microcontroller 21 is adopted for controlling the wireless transmission interface 22, the digital/analog converter 23, the playing device 24, the storage device 25 and the monitor 26.

The wireless transmission interface 22 is connected to the microcontroller 21, and the wireless transmission interface 22 can receive the multimedia entertainment content transmitted from the wireless transmission interface 13 of the host end 1.

The digital/analog converter 23 is connected to the microcontroller 21 and is capable of converting the multimedia entertainment content into the playable format for the playing device 24.

The playing device 24 is connected to the digital/analog converter 23 for playing the multimedia entertainment content transmitted from the digital/analog converter 23, and the playing device 24 may be a speaker or an earphone.

The storage device 25 is connected to the microcontroller 21 and the digital/analog converter 23 and is capable of storing the multimedia entertainment content transmitted from the microcontroller 21 and the digital/analog converter 23. The storage device 25 comprises a storage media 251 and a buffer 252. The storage media 251 may be a flash memory.

The monitor 26 is connected to the microcontroller 21 and is capable of playing the multimedia entertainment content transmitted from the microcontroller 21. The monitor 26 may be a convention TV set or a LCD TV, or the like.

When a user desires to play a multimedia entertainment content via the receiving end 2, the multimedia entertainment content may be continuously downloading from the Internet via the transmission interface 12 connected to the host 11 of the host end 1. The multimedia entertainment content is decoded by the decoder 14 into a playable format for the receiving end 2. The decoded multimedia entertainment content is transmitted to the host 11 and then transmitted to the wireless transmission interface 22 of the receiving end 2 via the wireless transmission interface 13 of the host end 1 and then to the microcontroller 21. Furthermore, the microcontroller 21 transmits the decoded multimedia entertainment content to the digital/analog converter 23 for converting into a playable format for the playing device 24, or the microcontroller 21 transmits the decoded multimedia entertainment content to the monitor 26 for displaying the image. Thus, the receiving end 2 may play the multimedia entertainment content continuously and limitlessly regardless of the capacity of the storage device 25 and thereby enabling the user to unlimitedly enjoy the multimedia entertainment content.

Furthermore, because the receiving end 2 is adopted for only receiving and playing the multimedia entertainment content transmitted from the host end 1 without storage, the user need not worry about the legal problem.

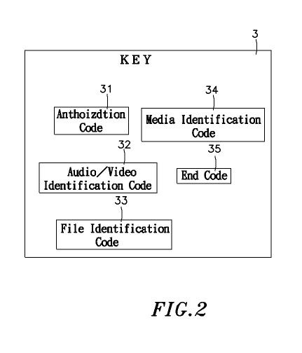

Referring to FIGS. 1 and 2, to download the multimedia entertainment content from the Internet via host 11 of the host end 1, the user may operate various keys 3 for this task. If the user wish to store the multimedia entertainment content into the storage device 25 of the receiving end 2 transmitted from the host end 1, the user may be required to pay or employ other methods to obtain an authorization code 31 of the key 3 into the multimedia entertainment content during the transmission from the host end 1 to the receiving end 2, and the receiving end 2 via the microcontroller 21 to judges whether the multimedia entertainment content contains the authorization code 31, wherein if the multimedia entertainment content contains the authorization code 31, the multimedia entertainment content is stored into the storage device 25, and if multimedia entertainment content doe not contain the authorization code 31, the multimedia entertainment content is merely being played or displayed via the playing device 24 or the monitor 26. Thus, the user may legally play or store the multimedia entertainment content.

Additionally, the key 3 can be the audio/video identification code 32, the file identification code 33, the media identification code 34 or the end code 35 for the multimedia entertainment content, and the microcontroller 21 of the receiving end 2 can use the codes of the key 3 to execute and the host end 1 can effectively control the execution of the receiving end 2.

Accordingly, the present invention has at least the following advantages.

1. The transmission interface of the host end is adopted for connecting to the Internet for receiving and transmitting the multimedia entertainment content and to transmit to the receiving end via the wireless transmission interface so that the receiving end can continuously play the multimedia entertainment content regardless of the capacity of the storage device. Thus, the multimedia entertainment content may be unlimited played.

2. The host end is adopted for downloading the multimedia entertainment content from the Internet, which is operated with various keys allowing the user to pay or to use other legal methods for storing or play the multimedia entertainment content transmitted from the host end to the receiving end. Thus, the authorization code of the key would provide a choice to the user whether or not make payment in order to store the multimedia entertainment content of the Interest into a storage device, or make payment for playing the multimedia entertainment content without storing into the storage device. Therefore, the user can legally enjoy the multimedia entertainment content. Furthermore, the key may be an audio/video identification code, a file identification code, a media identification code or an end code for the multimedia entertainment content, and the microcontroller of the receiving end may use the codes of the key to execute the operation.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A multimedia player having a host end and a receiving end, comprising:
the host end, comprising a host connected to a transmission interface and a wireless transmission interface, wherein the transmission interface is adopted for connecting to the Internet for downloading a multimedia entertainment content and the wireless transmission interface is adopted for transmitting the multimedia entertainment content from the host to the receiving end; and
the receiving end, comprising a microcontroller connected to a wireless transmission interface adopted for receiving the multimedia entertainment content transmitted from the wireless transmission interface of the host end, and a digital/analog converter for converting the multimedia entertainment content into a playable format for a playing device, wherein the microcontroller and the digital/analog converter are connected to a monitor and a playing device respectively.

2. The multimedia player according to claim 1, wherein a decoder is installed between the transmission interface and the Internet.

3. The multimedia player according to claim 1, wherein the host comprises a computer.

4. The multimedia player according to claim 1, wherein the multimedia entertainment content comprises audio/video data.

5. The multimedia player according to claim 1, wherein the multimedia entertainment content comprises digital music.

6. The multimedia player according to claim 1, wherein the playing device comprises a speaker.

7. The multimedia player according to claim 1, wherein the playing device comprises an earphone.

8. The multimedia player according to claim 1, wherein the monitor comprises a TV set.

9. The multimedia player according to claim 1, wherein the monitor comprises a LCD TV.

10. A multimedia player having a host end and a receiving end, comprising:
the host end, comprising a host connected to a transmission interface and a wireless transmission interface, wherein the transmission interface is adopted for connecting to the Internet for downloading a multimedia entertainment content and the wireless transmission interface is adapted for transmitting the multimedia entertainment content from the host to the receiving end, and wherein the multimedia entertainment content comprises a key; and
the receiving end, comprising a microcontroller connected to the wireless transmission interface adopted for receiving the multimedia entertainment content transmitted from the wireless transmission interface of the host end, a digital/analog converter for converting the multimedia entertainment content into a playable format for a playing device, and a storage device for storing the multimedia entertainment content, and wherein the microcontroller and the digital/analog converter are connected to a monitor and a playing device respectively.

11. The multimedia player according to claim 10, wherein the host comprises a computer.

12. The multimedia player according to claim 10, wherein the storage device further comprises a storage media and a buffer.

13. The multimedia player according to claim 12, wherein the storage media comprises a flash memory.

14. The multimedia player according to claim 10, wherein the key comprises an authorization code.

15. The multimedia player according to claim 10, wherein the key comprises an audio/video identification code.

16. The multimedia player according to claim 10, wherein the multimedia entertainment content comprises audio/video data.

17. The multimedia player according to claim 10, wherein the multimedia entertainment content comprises digital music.

18. The multimedia player according to claim 10, wherein the playing device comprises a speaker or earphone.

19. The multimedia player according to claim 10, wherein the monitor comprises a TV set or a LCD TV.

20. The multimedia player according to claim 10, wherein a decoder is installed between said transmission interface and the Internet.
